(19) United States
(12) Patent Application Publication
(10) Pub. No.: US 2026/0214359 A1
(43) Pub. Date: Jul. 23, 2026

(54) READOUT CIRCUIT FOR INFRARED DETECTOR

(71) Applicant: THALES, MEUDON (FR)

(72) Inventors: Vincent GUERIAUX, ELANCOURT (FR); Eric BELHAIRE, ELANCOURT (FR)

(21) Appl. No.: 19/142,056

(22) PCT Filed: Dec. 15, 2023
(86) PCT No.: PCT/EP2023/086054

§ 371 Date: Jun. 20, 2025

(30) Foreign Application Priority Data
Dec. 22, 2022 (FR) 2214217

(51) Int. Cl. H04N 25/78; H04N 25/20; H04N 25/53; H04N 25/67; H04N 25/771

(52) U.S. Cl. CPC H04N 25/78; H04N 25/20; H04N 25/53; H04N 25/771; H04N 25/67

(57) ABSTRACT

A readout circuit for an infrared detector includes: a pixel array circuit, each pixel including a capacitor, referred to as an integration capacitor; a memory unit having a memory location for each pixel of the array circuit. The readout circuit is configured to acquire an image from the infrared detector for a period of time, referred to as the frame time, by iteratively implementing the following steps: an integration step wherein the integration capacitors are charged with photoelectrons from the infrared detector for a period of time, referred to as the elementary integration time, the elementary integration time being configured such that the respective charges of the integration capacitors remain lower than a maximum allowable charge; a storage step wherein, for each pixel, the quantity of charge of the respective integration capacitor at the end of the elementary integration time is added to a value stored in the memory location corresponding to the pixel; a step of resetting the integration capacitor to the initial state; and, at the end of the frame time, by transmitting image data including the values stored in the memory locations of the memory unit.

### CROSS-REFERENCE TO RELATED APPLICATIONS

This application is a National Stage of International patent application PCT/EP2023/086054, filed on Dec. 15, 2023, which claims priority to foreign French patent application No. FR 2214217, filed on Dec. 22, 2022, the disclosures of which are incorporated by reference in their entireties.

### FIELD OF THE INVENTION

The invention relates to the field of infrared detectors and in particular to a readout circuit for an infrared detector, and to an image acquisition device comprising an infrared detector and a readout circuit according to the invention.

Generally, in the field of infrared imaging, an image acquisition device comprises an optical focusing system which will conjugate a scene observed with an infrared detector and thus project an image of the scene onto the detector. An example of an image acquisition device 10 is partially shown in FIG. 1.

### BACKGROUND

Infrared detection is carried out by an infrared detector 12 which is typically a quantum or photonic detector. The infrared detector 12 comprises a semiconductor material which is sensitive to the radiation λ to be detected. The detection principle is based on the photoelectric effect within the semiconductor material which therefore carries out a transducer function by converting a photonic flux into a current. The semiconductor material may be a small-gap semiconductor material such as indium antimonide InSb or mercury-cadmium telluride HgCdTe 12b, combined with a substrate 12a made of cadmium-zinc telluride CdZnTe. The semiconductor material may also be a meta-material such as a type-2 superlattice, or a multi-quantum well material. The detector 12 is structured as a pixel array, each pixel forming a photosensor which is intended to detect an element of the image. The size of the pixel is of the order of a few micrometers. Typically, it is between 5 and 30 μm from the side. The plane formed by the pixel array is generally called the focal plane. In order to allow signals to be generated by the detector 12 and processed, it is necessary to combine it with a readout circuit 16. The readout circuit 16 itself also comprises an array circuit. Each pixel of the detector 12 is then connected to a respective pixel of the readout circuit 16 by a connection array 14. Such a connection array 14 may be made of indium beads and obtained by a hybridization method. The readout circuit 16 may be implemented in CMOS (Complementary Metal-Oxide-Semiconductor) technology. During operation of the image acquisition device, each pixel of the detector 12 absorbs the incident photons and releases a proportional quantity of electrons which will be processed by the readout circuit 16.

FIG. 2 gives a simplified electrical representation of the imaging device 10. Electrically, a pixel of the detector 12 has a photodiode function 120. The corresponding pixel 160 of the readout circuit 16 makes it possible to polarize the photodiode 120 to allow the generation of photoelectrons. It also ensures the accumulation of the charges from the photodiode 120. The readout circuit 16 uses these accumulated charges to determine a light value of the element of the image detected by the corresponding pixel of the detector 12. The period of time of accumulating the charges in the readout circuit is called the integration time. The pixel 160 of the readout circuit 16 comprises in particular a capacitor C_{INT}, referred to as an integration capacitor, which makes it possible to convert the quantity of charges into a voltage. The pixel 160 comprises other components which allow it to carry out a sample-and-hold function and a function of resetting the integration capacitor to zero. The phase of integrating the charges is followed by a phase of reading out the information stored in the pixel 160 of the readout circuit 16.

The array circuit of the readout circuit 16 comprises a plurality of rows and columns, for example 512 rows and 640 columns of pixels. The reading-out phase is then made possible by an addressing system using multiplexers 162, 166 making it possible to address the pixels, row by row and column by column. Generally, the pixels are processed in groups of pixels processed in parallel. Thus, for example, pixels belonging to the same row may be processed in parallel. To this end, each column of the array circuit of the readout circuit 16 comprises a row multiplexer 162 configured to select a pixel from the column. During the addressing operation, at least some of the row multiplexers 162 operate in parallel to select a respective pixel of the same row. All the pixels of the same row may be processed in parallel. Alternatively, some of the pixels of the same row are processed in parallel. A column multiplexer 166 then makes it possible to select the column or columns of the array circuit 160 involved in this parallel processing. The signal from each pixel is then amplified by an amplifier circuit 164. There is in particular one amplifier circuit 164 per column. The signal of the pixel 160 may then be made available at the output 168 of the readout circuit 16. Generally, the level of the pixel 160 is converted into digital data by an analog-to-digital converter. The analog-to-digital converter is in particular located at the end of the column, or at the output 168 or else outside the readout circuit 16. In infrared imaging applications, digital data are in particular encoded on 14 bits.

In respect of the readout circuit 16, at the end of the integration time, the information stored in the pixels, namely the level of charge or the voltage of the integration capacitor, is transmitted at the output 168 for reconstitution of the image detected by the detector 12. In particular, in the acquisition of a video, the images are successively acquired periodically. The period between two successive images is in particular the frame time.

In an optimal mode of operation, the noise on the signal is mainly due to background radiation. The infrared detectors are then designated as BLIP detectors (BLIP standing for “Background Limited Infrared Photodetector”). The dominant noise is then related to the shot noise which is intrinsic to the quantum nature of light. This is a Poissonian noise, this meaning that it increases in line with the root of the signal. The signal-to-noise ratio is therefore proportional to the root of the signal.

In the case of an infrared image acquisition device, in order to increase the signal received by the detector 12, it is possible to play with the optical parameters, for example the spectral band, the transmission, the opening, the pixel pitch or the quantum efficiency. Once these electro-optical conditions have been fixed, the only way to increase the signal is to increase the integration time. The signal-to-noise ratio is at best proportional to the root of the integration time. The longer the integration time, the better the signal-to-noise ratio. In an ideal video system, the integration time is limited by the chosen video frame rate, namely the frame time. Thus, imaging at 100 Hz allows a maximum integration time of 10 ms. It is then necessary to ensure that the maximum storable charge associated with the integration capacitor of a pixel is sufficient to accumulate the signal during the integration time. However, the achievable integration capacitor is limited by the surface area of the pixel.

For certain wavelengths λ, the photon flux is too great for the integration capacitor C_{INT}. The latter is not large enough to be able to integrate all the electrons generated by the photons during the frame time. This is in particular the case for radiation in the atmospheric transmission band, referred to as long-wavelength radiation or band 3 radiation. This radiation typically has a spectral band ranging from 8 to 14 μm. This leads to a reduction in the integration time and therefore to a degradation of the signal-to-noise ratio and thus of the sensitivity of the image acquisition device.

Patent application publication WO2015/016991 and patent publication EP2687020 describe a solution consisting in allowing complete charges of the integration capacitor during the integration time. The integration capacitor is discharged each time. The number of charge cycles is counted making it possible to count the quantity of charges received during the integration time. This solution overcomes the constraint associated with the maximum charge storable by the integration capacitor. However, it requires analog-to-digital conversion, namely the counting, to be performed in the pixel. In order to keep the size of the pixel small, very advanced and expensive technologies, for example CMOS, are needed, which degrade the industrial profitability of infrared imaging devices. Furthermore, the power consumption per pixel is greater than a conventional readout circuit. This is particularly disadvantageous in constrained environments, such as, for example, an application for detecting infrared images in a cryogenic environment.

A simple and relatively low-consumption solution is therefore sought which makes it possible to overcome the maximum charge acceptable by an integration capacitor during the integration time.

### SUMMARY OF THE INVENTION

To this end, the invention proposes a readout circuit for an infrared detector, comprising:
i. a pixel array circuit, each pixel comprising a capacitor, referred to as an integration capacitor;
ii. a memory unit having a memory location for each pixel of the array circuit; and
said readout circuit being configured to acquire an image from the infrared detector for a period of time, referred to as the frame time, by iteratively implementing the following steps:
i. an integration step in which the integration capacitors are charged with photoelectrons from the infrared detector for a period of time, referred to as the elementary integration time, said elementary integration time being configured such that the respective charges of the integration capacitors remain lower than a maximum allowable charge;
ii. a storage step in which, for each pixel, the quantity of charge of the respective integration capacitor at the end of the elementary integration time is added to a value stored in the memory location corresponding to the pixel;
iii. a step of resetting the integration capacitor to the initial state;
   and, at the end of the frame time, by transmitting image data comprising the values stored in the memory locations of the memory unit. For a number N of iterations, the total integration time is equal to N times the elementary integration time.

In the readout circuit according to the invention, the quantity of electric charge stored by the integration capacitor over the elementary integration time remains less than the maximum allowable charge. Thus, unlike in the prior art, there are no complete charge cycles during the elementary integration time. However, over a frame time, a high signal value may be obtained because the charges obtained during multiple successive elementary integrations are added. The invention therefore makes it possible to improve the signal-to-noise ratio, without modifying the circuit of a pixel of a conventional readout circuit. Unlike in the prior art, the pixel is in particular devoid of analog-to-digital conversion means within it. Thus, the circuit of the pixel is simplified and consumes less than the prior art previously mentioned, all while allowing an improved signal-to-noise ratio.

According to one embodiment, the readout circuit comprises:
i. at least one analog-to-digital converter configured to, in the storage step, convert the quantity of charge of the integration capacitor into a digital value; and
ii. at least one adder configured to, in the storage step, add said digital value to the value stored in the memory location corresponding to the pixel.

According to one embodiment, the analog-to-digital converter and/or the adder are shared by a set of pixels of the array circuit.

According to one embodiment, the readout circuit is configured such that, upon the first execution of the integration and storage steps in the frame time, the initial value stored in the memory locations of the memory unit is zero.

According to one embodiment, the readout circuit is configured to, prior to the iteratively implemented steps, implement the following steps:
i. an integration step in which the integration capacitors are charged with photoelectrons from the infrared detector for the elementary integration time;
ii. a storage step in which, for each pixel, the quantity of charge of the respective integration capacitor at the end of the elementary integration time is stored in the memory location corresponding to the pixel;
iii. a step of resetting the integration capacitor to the initial state.

According to one embodiment, the readout circuit is configured to, in the frame time, shift the values stored in the memory locations as a function of a movement of an image formed on the infrared detector.

The invention also relates to an infrared image acquisition device intended to acquire at least one image of a scene, comprising:
i. an infrared detector forming an array detector having a plurality of pixels, said infrared detector being configured to receive the at least one image of said scene;
ii. a readout circuit according to the invention, configured to process signals received from the infrared detector which are representative of the at least one image.

According to one embodiment, the infrared image acquisition device further comprises a scanning device configured to scan the scene in one direction, such that the image of the scene moves on the infrared detector during the frame time, said readout circuit being configured to shift the values stored in the memory locations as a function of the movement of the image on the detector.

The invention also relates to a cryostat comprising an infrared image acquisition device according to the invention.

The invention further relates to an image acquisition method using a device comprising an infrared detector and a readout circuit which comprises a pixel array circuit, each pixel comprising a capacitor, referred to as an integration capacitor; and a memory unit having a memory location for each pixel of the array circuit, said method comprising, for a period of time, referred to as the frame time, iteratively implementing the following steps:
i. an integration step in which the integration capacitors are charged with photoelectrons from the infrared detector for a period of time, referred to as the elementary integration time, said elementary integration time being configured such that the respective charges of the integration capacitors remain lower than a maximum allowable charge;
ii. a storage step in which, for each pixel, the quantity of charge of the respective integration capacitor at the end of the elementary integration time is added to a value stored in the memory location corresponding to the pixel; and
iii. a step of resetting the integration capacitor to the initial state;
   the method further comprising, at the end of the frame time, transmitting image data comprising the values stored in the memory locations of the memory unit.

### BRIEF DESCRIPTION OF THE DRAWINGS

Other features and advantages of the present invention will become clearer on reading the following description in relation to the following appended figures:

FIG. 1, already described, shows an image acquisition device according to the prior art;

FIG. 2 shows a simplified electrical diagram of the image acquisition device illustrated in FIG. 1;

FIG. 3 shows an example of a readout circuit according to the invention;

FIG. 4 is a block diagram illustrating an example of a method according to the invention;

FIG. 5 is a timing diagram illustrating the example of the method;

FIG. 6 shows another example of a readout circuit according to the invention.

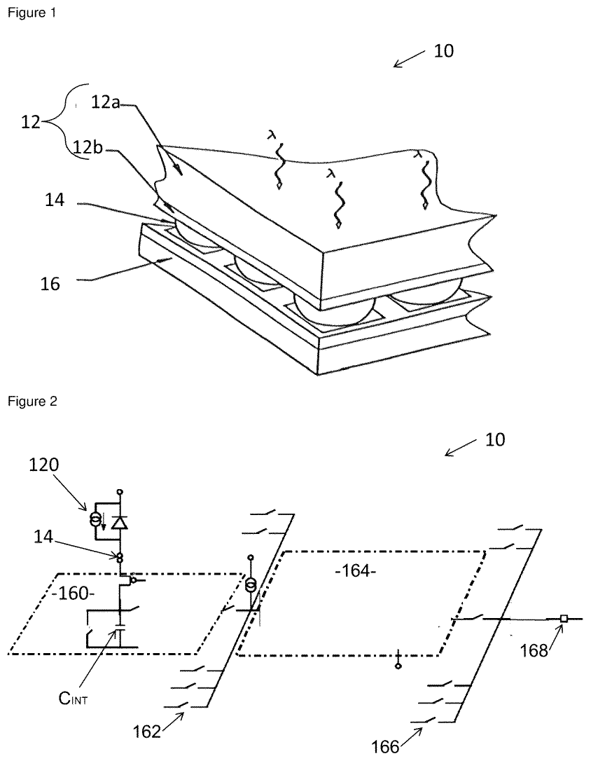

### DETAILED DESCRIPTION

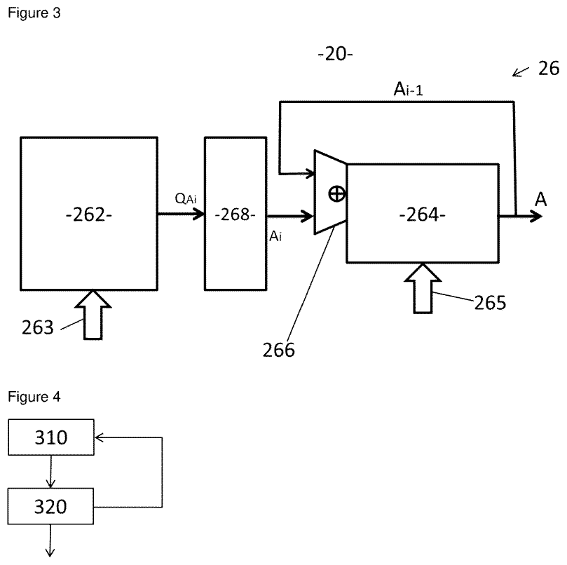

FIG. 3 illustrates an example of an infrared image acquisition device 20 according to the invention, in which only one readout circuit 26 is shown. The readout circuit 26 is combined with an infrared detector known per se, the pixels of which produce photoelectrons under the effect of infrared radiation. By having a photodiode operation, each pixel of the detector supplies a current to a respective pixel of an array circuit 262 of the readout circuit 26. The pixel of the array circuit 262 may comprise a P-MOS or N-MOS transistor for polarizing the photodiode.

The array circuit 262 forms an array of pixels. The pixels are arranged in columns and rows, in particular over all of the array circuit 262. The array circuit 262 may be made in CMOS technology. The pixel comprises an integration capacitor which will accumulate the electrical charges produced by the corresponding pixel of the detector. In particular, in a manner known per se, each pixel comprises other components such as a sample-and-hold device and a device for resetting the integration capacitor to zero. A first addressing system 263, such as a multiplexer, makes it possible in particular to access a pixel of the array circuit 262.

The readout circuit 26 further comprises a memory unit 264 which comprises a memory location for each pixel of the array circuit 262. The memory unit 264 is, for example, a dynamic memory, such as a DRAM (Dynamic Random Access Memory), or a static memory, such as an SRAM (Static Random Access Memory). A second addressing system 265 makes it possible in particular to access a memory location of the memory unit 264. In particular, the memory unit 264 forms a monolithic unit within the readout circuit 26. Thus, unlike in the prior art, the memory locations are not inside the pixel but in a single separate unit. This removes a constraint regarding the size of the pixel.

The readout circuit 26 may comprise an analog-to-digital converter 268 which converts a quantity of charge Q_{Ai} accumulated in the integration capacitor during the elementary integration time into a representative digital value Aᵢ.

The readout circuit 26 comprises in particular an adder 266 which receives at input the value Ai representative of the charge accumulated in the integration capacitor during an elementary integration time, and adds it to the existing value Aᵢ₋₁ already stored in the memory unit 264. The value Aᵢ₋₁ corresponds to a value representative of a quantity of charge obtained at the end of a previous elementary integration time. The result of this addition operation is stored in the memory unit 264.

The readout circuit 26 forms in particular an integrated electronic circuit. Its elements are in particular assembled on the same electronic chip.

At the end of a frame time, the last value A stored in the memory location is transmitted at the output of the readout circuit 26.

FIG. 4 illustrates the steps implemented by the readout circuit 26 during acquisition of an image for a period of time, referred to as the frame time. In a step 310, the integration capacitors of the pixels are charged with photoelectrons from the respective pixels of the infrared detector. The charges are accumulated for a period of time, referred to as the elementary integration time. The elementary integration time is chosen such that the respective charges of the integration capacitors remain lower than a maximum charge allowable by the integration capacitors. Thus, unlike in the prior art, a complete charge of the integration capacitor is not permitted. Then, during a storage step 320, the charge reached by the integration capacitor at the end of the integration step 310 is added to the value stored in the memory location corresponding to the pixel. The integration capacitor is then reset to the initial state so as to be available for the next elementary integration time.

These steps 310, 320 are repeated for the frame time. At the end of the frame time, image data comprising the values stored in the memory locations of the memory unit 264 are made available at the output of the readout circuit 26.

Thus, during image acquisition during the frame time, the readout circuit 26 locally accumulates in the memory unit 26 intermediate images, referred to as “thumbnails”, which are added to form the image transmitted at output by the readout circuit 26 at the end of the frame time. In particular, each thumbnail is formed at the end of an elementary integration time. It is added to a thumbnail already stored in the memory location and replaces this old thumbnail in the memory unit 264.

In particular, at the start of the frame time, upon the first execution of the integration 310 and storage 320 steps, the initial value stored in the memory locations is zero. Hence, at the end of the first integration 310 and storage 320 steps, the value stored in the memory location corresponding to the pixel is the quantity of charge of the integration capacitor obtained at the end of the first elementary integration step. This initiation of the image acquisition may be implemented differently. For example, during the first storage step in the frame time, the addition operation is inhibited. The value stored in the memory location corresponding to the pixel is then the quantity of charge of the integration capacitor obtained at the end of the first integration step.

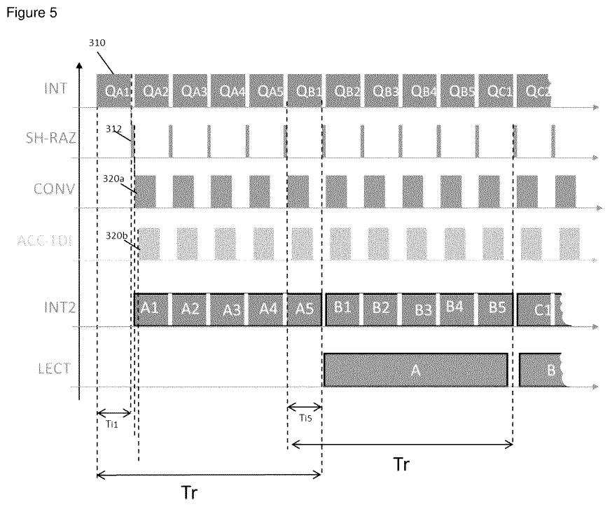

FIG. 5 shows a timing diagram illustrating this succession of elementary integration times in the readout circuit 26. In the following description, one pixel will be concerned, knowing that it applies to all the pixels of the array circuit 262. The first row represents a signal INT for activating the integration 310, the second a signal SH-RAZ for activating the resetting of the charge of the integration capacitor to the initial value, the third a signal CONV for activating the analog-to-digital conversion, the fourth a signal ACC-TDI for activating the storage of the value in the memory unit 264, the fifth a signal INT2 for acquiring the image A, B, the sixth row a signal LECT for transmitting the image A, B at the output of the readout circuit 26.

An image A is acquired during the frame time Tr. To this end, a succession of thumbnails A1, A2, A3, A4, A5 are detected one after the other and progressively added to each other. In particular, in a first elementary integration time Tᵢ₁, a first charge Q_{A1} is accumulated in the integration capacitor during an integration step 310. The integration capacitor of the pixel is progressively charged by the photoelectrons from the corresponding pixel of the detector. In particular, during a step 312, the voltage of the integration capacitor is read out to determine the quantity of charges received during the elementary integration time Tᵢ₁, and the integration capacitor is reset to the initial state to allow successive integration 310 of another thumbnail A2. In a step 320a, the quantity of charge Q_{A1} accumulated in the integration capacitor may be converted into a representative digital value A1. Then, in a step 320b, the quantity of charge of the integration capacitor, in particular the representative digital value A1, at the end of the elementary integration time, is added to a value stored in the memory unit 264 at the memory location corresponding to the pixel of the array circuit 262.

During the first storage step 320 of the frame time Tr, the value initially stored in the memory location is preferably zero.

Alternatively, during the first storage step 320 of the frame time Tr, the addition operation is deactivated and the digital value A1 is stored directly in the memory location of the memory unit 264.

Then, the following digital values A2, A3, A4, A5 are obtained and progressively added and stored in the memory location corresponding to the pixel. At the end of the last elementary integration time Tᵢ₅ for the image A, the last value stored in the memory location is transmitted at the output of the readout circuit 26. This last value is the image datum A for the total integration time Tᵢₙₜ in the frame time Tr. This total integration time Tᵢₙₜ is defined by the relationship:

$${T}_{int} = N \times {T}_{i}$$

Where N is the number of successive elementary integration times Tᵢ in the frame time Tr.

Similarly, other images B, C are acquired and transmitted. As shown, certain steps may be carried out at least partially in parallel when this is possible, in order to save processing time.

In particular, each memory location is preferably greater than or equal to 19 bits in order to allow an accumulation of N=2⁵=32 thumbnails. The signal-to-noise ratio of the image A is then improved by a factor √N compared with a single thumbnail.

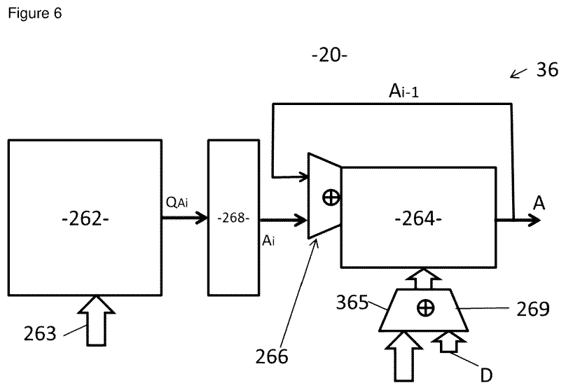

FIG. 6 illustrates an example of one embodiment of the readout circuit 36. The readout circuit 36 is similar to that illustrated in FIG. 3, except for the addressing system 365 of the memory unit 264. In this readout circuit 36, the addressing of the memory locations may undergo a shift D, for example a shift of rows and/or columns. Such a shift D is a function of a movement of an image formed on the detector. Such a readout circuit 36 is particularly advantageous for an image acquisition device comprising a scanning device, in particular an opto-mechanical scanning unit, as disclosed for example in published patent applications FR2830339 and FR3112229.

The shift D is in particular applied during the storage step 320. The shift D may be less than or equal to 10% of the number of rows or columns. For example, if the scanning direction extends along the columns of the array detector, each row of the scene will be seen by multiple rows of the array detector. The shift D corresponds to the scan. Acquiring the image A over multiple pixels reduces fixed spatial noise. Such spatial noise is inherent in infrared technologies and corresponds to a dispersion and/or a response shift between the pixels. Typically, this spatial noise may be reduced by using a pixel non-uniformity correction (NUC) table. However, there is still a residual fixed spatial noise which is generally decorrelated from pixel to pixel. The example of a readout circuit 36 according to this embodiment makes it possible to process the image obtained by scanning in a simplified manner compared with the prior art. Acquiring a point of the scene by M different pixels makes it possible to reduce the residual spatial noise by a factor √M.

The operation of the readout circuit 26, 36 has been explained with respect to one pixel. In the schematic representations of FIGS. 3 and 6, a single analog-to-digital converter 268 and a single adder 266 are shown. However, in a manner known per se, the pixels may be processed in parallel for a group of pixels. The readout circuit 26, 36 may thus comprise a plurality of analog-to-digital converters 268 and a plurality of adders 264. In particular, the pixels may be processed row by row. The readout circuit 26, 36 may comprise one analog-to-digital converter 268 per column, or analog-to-digital converters 268 each shared by a respective set of columns. In the latter case, a multiplexer may be used to allocate an analog-to-digital converter 268 to multiple columns. Equally, the readout circuit 26, 36 may comprise one adder 266 per analog-to-digital converter 268, or adders 266 each shared by a respective set of analog-to-digital converters 268. In the latter case, a multiplexer may be used to allocate an adder 266 to multiple analog-to-digital converters 268.

The readout circuit 26, 36 makes it possible to detect an image in a simple manner with an improved signal-to-noise ratio and reduced consumption compared with the prior art. An image acquisition device comprising the readout circuit 26, 36 is particularly advantageous for use in a cryostat. Specifically, infrared detectors operate at cryogenic temperature, in particular at 70 K or 80 K, and even at lower than 70 K for components which are sensitive to long wavelengths of between 8 and 14 μm. The cryostat is typically cooled by a cryogenic cooling device, generally based on a Stirling cycle, or by a pressure wave. The electrothermal efficiency of such a cooling device is generally low.

For example, a cryostat comprises a conventional infrared image acquisition device which operates at a temperature of approximately 70 K. The readout circuit consumes around 50 mW. The cooling device consumes 5 W at an external ambient temperature of 20° C. and doubles it at an ambient temperature of 70° C. An equivalent cryostat having a detector using a readout circuit designed to reduce the noise as in the prior art consumes around 1 W. This corresponds to a consumption of the cooling device of the order of 100 W. Such a consumption for the cooling makes this device difficult to use in the majority of cryostats, unlike the readout circuit 26, 36 which has a lower power consumption.

1. A readout circuit for an infrared detector, comprising:
a pixel array circuit, each pixel comprising a capacitor, referred to as an integration capacitor;
a memory unit having a memory location for each pixel of the array circuit; and
said readout circuit being configured to acquire an image (A, B) from the infrared detector for a period of time, referred to as the frame time (Tr), by iteratively implementing the following steps, for each pixel:
an integration step (310) wherein the respective integration capacitor is charged with photoelectrons from the infrared detector for a period of time, referred to as the elementary integration time (Tᵢ), said elementary integration time (Tᵢ) being configured such that the charge of the integration capacitor remains lower than a maximum allowable charge;
a step (320a), wherein the quantity of charge (Q_{Ai}) accumulated in the integration capacitor at the end of the elementary integration time (Tᵢ) is converted into a representative digital value (Aᵢ);
a step (320b), wherein the digital value (Aᵢ) representative of the quantity of charge (Q_{Ai}) of the integration capacitor, at the end of the elementary integration time (Tᵢ), is added to a value stored in the memory unit at the memory location corresponding to the pixel of the array circuit;
a step of resetting the integration capacitor to the initial state to allow successive integration (310) of another digital value;
digital values (A1, A2, A3, A4, A5) being obtained and progressively added and stored in said memory location corresponding to the pixel;
and, at the end of the frame time (Tr), by transmitting image data (A, B) comprising the values stored in the memory locations of the memory unit;
the circuit being further configured to, in the frame time (Tr), shift the values stored in the memory locations as a function of a movement of an image formed on the infrared detector.

2. The readout circuit as claimed in claim 1, comprising:
at least one analog-to-digital converter configured to, in the storage step (320), convert the quantity of charge of the integration capacitor into a digital value; and
at least one adder configured to, in the storage step (320), add said digital value to the value stored in the memory location corresponding to the pixel.

3. The readout circuit as claimed in claim 2, wherein the analog-to-digital converter and/or the adder are shared by a set of pixels of the array circuit.

4. The readout circuit as claimed in claim 1, configured such that, upon the first execution of the integration (310) and storage (320) steps in the frame time (Tr), the initial value stored in the memory locations of the memory unit is zero.

5. The readout circuit as claimed in claim 1, configured to, prior to the iteratively implemented steps, implement the following steps:
an integration step (310) wherein the integration capacitors are charged with photoelectrons from the infrared detector for the elementary integration time (Tᵢ);
a storage step (320) wherein, for each pixel, the quantity of charge of the respective integration capacitor at the end of the elementary integration time (Tᵢ) is stored in the memory location corresponding to the pixel; and
a step of resetting the integration capacitor to the initial state.

6. An infrared image acquisition device intended to acquire at least one image of a scene, comprising:
an infrared detector forming an array detector having a plurality of pixels, said infrared detector being configured to receive the at least one image of said scene; and
a readout circuit as claimed in claim 1, configured to process signals received from the infrared detector which are representative of the at least one image.

7. The infrared image acquisition device as claimed in claim 6, further comprising a scanning device configured to scan the scene in one direction, such that the image of the scene moves on the infrared detector during the frame time (Tr), said readout circuit being configured to shift the values stored in the memory locations as a function of the movement of the image on the detector.

8. A cryostat comprising an infrared image acquisition device as claimed in claim 6.

9. An image acquisition method using a device comprising an infrared detector and a readout circuit which comprises a pixel array circuit, each pixel comprising a capacitor, referred to as an integration capacitor; and a memory unit having a memory location for each pixel of the array circuit,
said method comprising, for a period of time, referred to as the frame time (Tr), iteratively implementing the following steps, for each pixel:
an integration step (310) wherein the respective integration capacitor is charged with photoelectrons from the infrared detector for a period of time, referred to as the elementary integration time (Tᵢ), said elementary integration time (Tᵢ) being configured such that the charge of the integration capacitor remains lower than a maximum allowable charge;
a step (320a), wherein the quantity of charge (Q_{Ai}) accumulated in the integration capacitor at the end of the elementary integration time (Tᵢ) is converted into a representative digital value (Aᵢ);
a step (320b), wherein the digital value (Aᵢ) representative of the quantity of charge (Q_{Ai}) of the integration capacitor, at the end of the elementary integration time (Tᵢ), is added to a value stored in the memory unit at the memory location corresponding to the pixel of the array circuit; and
a step of resetting the integration capacitor to the initial state to allow successive integration (310) of another digital value;
digital values (A1, A2, A3, A4, A5) being obtained and progressively added and stored in said memory location corresponding to the pixel;
said method further comprising, at the end of the frame time (Tr), transmitting image data (A, B) comprising the values stored in the memory locations of the memory unit; and in the frame time (Tr), shifting the values stored in the memory locations as a function of a movement of an image formed on the infrared detector.
